(19) United States
(12) Patent Application Publication
(10) Pub. No.: US 2020/0050938 A1
(43) Pub. Date: Feb. 13, 2020

(54) SYSTEMS AND METHODS FOR IMPROVEMENT OF INDEX PREDICTION AND MODEL BUILDING

(71) Applicant: BEIJING DIDI INFINITY TECHNOLOGY AND DEVELOPMENT CO., LTD., Beijing (CN)

(72) Inventors: Junqiang FU, Beijing (CN); Pei LI, Beijing (CN); Fan YANG, Beijing (CN)

(73) Assignee: BEIJING DIDI INFINITY TECHNOLOGY AND DEVELOPMENT CO., LTD., Beijing (CN)

(21) Appl. No.: 16/658,587

(22) Filed: Oct. 21, 2019

Related U.S. Application Data
(63) Continuation of application No. PCT/CN2017/104129, filed on Sep. 28, 2017.

(30) Foreign Application Priority Data
May 25, 2017 (CN) 201710378094.X

(51) Int. Cl. G06N 3/08; G06K 9/62

(52) U.S. Cl. CPC G06N 3/08; G06K 9/6256

(57) ABSTRACT

A system includes one or more storage medium storing a set of instructions and at least one processor in communication with the storage device. When executing the instructions, the at least one processor is configured to cause the system to determine one or more preliminary target sub-areas among a plurality of sub-areas that make up an area; obtain a trained model that is configured to generate a value for a first indicator; obtain feature information of the one or more features for each of the one or more preliminary target sub-areas; and determine a value of the first indicator at a designated time for each of the one or more preliminary target sub-areas based on the trained model and the feature information.

### CROSS-REFERENCE TO RELATED APPLICATION

This application is a continuation of International No. PCT/CN2017/104129, filed on Sep. 28, 2017, which claims priority of Chinese Patent Application No. 201710378094.X, filed on May 25, 2017, the contents of which are incorporated herein by reference.

### TECHNICAL FIELD

The present disclosure generally relates to Online to Offline (O2O) service platforms, and in particular, to systems and methods for index prediction and model building in an online O2O service platforms.

### BACKGROUND

With the development of Internet technology, O2O services, such as online taxi hailing services and delivery services, play a more and more significant role in people's daily lives. For example, online taxi-hailing has been heavily used by passengers. Through an online O2O service platform, the user can request an O2O service in the form of an application installed in a user equipment, such as a smartphone terminal. To improve the operation efficiency of the online O2O service platform, a large area where service providers provide an O2O service is often divided into a plurality of sub-areas. Strategic division, categorization, and selection of the sub-areas may improve the prediction of business indexes and/or the building of business models. Thus, it is desirable to develop effective systems and methods to divide an area in the online O2O service platform.

### SUMMARY

According to an aspect of the present disclosure, a system may include at least one non-transitory computer-readable storage medium storing a set of instructions and at least one processor in communication with the at least one non-transitory computer-readable storage medium. When executing the set of instructions, the at least one processor may cause the system to determine one or more preliminary target sub-areas among a plurality of sub-areas that make up an area. The at least one processor may also cause the system to obtain a trained model that is configured to generate a value for a first indicator based on one or more features related to each of the preliminary target sub-areas. The at least one processor may also cause the system to obtain, for each of the one or more preliminary target sub-areas, feature information of the one or more features, at least part of the feature information being associated with a designated time. The at least one processor may also cause the system to determine a value of the first indicator at the designated time for each of the one or more preliminary target sub-areas based on the trained model and the feature information.

In some embodiments, the at least one processor may also cause the system to obtain a historical value of a second indicator of each of the plurality of sub-areas, and determine the one or more preliminary target sub-areas among the plurality of sub-areas based on the historical values of the second indicator of the plurality of sub-areas.

In some embodiments, the at least one processor may also cause the system to determine, for each of the plurality of sub-areas, whether the historical value of the second indicator exceeds a first threshold. For each of the plurality of sub-areas, upon a determination that the historical value of the second indicator exceeds the first threshold, the at least one processor may further cause the system to designate the sub-area as the one or more preliminary target sub-areas

In some embodiments, the at least one processor may also cause the system to divide the area into the plurality of sub-areas according to a pre-determined rule before determining one or more preliminary target sub-areas.

In some embodiments, the at least one processor may also cause the system to determine one or more target sub-areas based on the values of the first indicator of the one or more preliminary target sub-areas.

In some embodiments, the at least one processor may also cause the system to redistribute one or more resources among the target sub-areas based on the values of the first indicator of the preliminary target sub-areas.

In some embodiments, the at least one processor may also cause the system to perform step (1) to obtain historical feature information of the one or more features and historical values of the first indicator of a plurality of preliminary target sub-areas, and perform step (2) to train a preliminary model with a first portion of the historical feature information and historical values by using a loss function, wherein the loss function is based on predicted values generated by the preliminary model and the first portion of the historical values of the first indicator. In some embodiments, the at least one processor may further cause the system to perform step (3) to repeat steps (1)-(2) upon a determination that the loss of function is more than a second threshold, or designate the preliminary model as a trained preliminary model related to the first indicator upon a determination that the loss function is less than the second threshold.

In some embodiments, the at least one processor may also cause the system to perform step (4) to verify the trained preliminary model with a second portion of the historical feature information and historical values by determining a model validation parameter is less than a third threshold, and perform step (5) to repeat steps (1)-(3) upon a determination that the validation parameter is more than the third threshold, or designate the trained preliminary model as the trained model upon a determination that the model validation parameter is less than the third threshold.

In some embodiments, the trained model related to the first indicator may be a gradient boosting decision tree (GBDT) model.

In some embodiments, the first indicator may be associated with at least one of a service supply, a service demand, and a demand-supply gap of an O2O service.

In some embodiments, the one or more features may include at least one of time, location, weather, traffic, policy, news, road condition, service order, service requester, and service provider.

According to another aspect of the present disclosure, a computer-implemented method may include one or more of the following operations performed by at least one processor. The method may include determining one or more preliminary target sub-areas among a plurality of sub-areas that make up an area. The method may also include obtaining a trained model that is configured to generate a value for a first indicator based on one or more features related to each of the preliminary target sub-areas. The method may also include obtaining, for each of the one or more preliminary target sub-areas, feature information of the one or more features, at least part of the feature information being associated with a designated time. The method may also include determining a value of the first indicator at the designated time for each of the one or more preliminary target sub-areas based on the trained model and the feature information.

According to yet another aspect of the present disclosure, a non-transitory machine-readable storage medium storing instructions that, when executed by at least one processor of a system, cause the system to perform a method. The method may include determining one or more preliminary target sub-areas among a plurality of sub-areas that make up an area. The method may also include obtaining a trained model that is configured to generate a value for a first indicator based on one or more features related to each of the preliminary target sub-areas. The method may also include obtaining, for each of the one or more preliminary target sub-areas, feature information of the one or more features, at least part of the feature information being associated with a designated time. The method may also include determining a value of the first indicator at the designated time for each of the one or more preliminary target sub-areas based on the trained model and the feature information.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a block diagram illustrating an exemplary O2O service system according to some embodiments of the present disclosure;

FIG. 2 is a schematic diagram illustrating exemplary hardware and software components of an exemplary computing device according to some embodiments of the present disclosure;

FIG. 3 is a schematic diagram illustrating exemplary hardware and/or software components of an exemplary mobile device on which a use terminal may be implemented according to some embodiments of the present disclosure;

FIG. 4 is a block diagram illustrating an exemplary processing engine according to some embodiments of the present disclosure;

FIG. 5 is a flowchart illustrating an exemplary process for dividing an area based on an indicator according to some embodiments of the present disclosure;

FIG. 6 is a flowchart illustrating an exemplary process for determining a preliminary target sub-area according to some embodiments of the present disclosure; and

FIG. 7 is a flowchart illustrating an exemplary process for determining a model related to an indicator according to some embodiments of the present disclosure.

### DETAILED DESCRIPTION

The following description is presented to enable any person skilled in the art to make and use the present disclosure, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the claims.

The terminology used herein is to describe particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate operations that systems implement according to some embodiments in the present disclosure. It is to be expressly understood, the operations of the flowchart may be implemented not in order. Conversely, the operations may be implemented in inverted order, or simultaneously. Moreover, one or more other operations may be added to the flowcharts. One or more operations may be removed from the flowcharts.

Moreover, while the system and method in the present disclosure is described primarily in regard to distributing a request for a transportation service, it should also be understood that the present disclosure is not intended to be limiting. The system or method of the present disclosure may be applied to any other kind of O2O service. For example, the system or method of the present disclosure may be applied to transportation systems of different environments including land, ocean, aerospace, or the like, or any combination thereof. The vehicle of the transportation systems may include a taxi, a private car, a hitch, a bus, a train, a bullet train, a high speed rail, a subway, a vessel, an aircraft, a spaceship, a hot-air balloon, a driverless vehicle, or the like, or any combination thereof. The transportation system may also include any transportation system for management and/or distribution, for example, a system for sending and/or receiving an express. The application of the system or method of the present disclosure may be implemented on a user device and include a webpage, a plug-in of a browser, a client terminal, a custom system, an internal analysis system, an artificial intelligence robot, or the like, or any combination thereof.

The term “passenger,” “requester,” “service requester,” and “customer” in the present disclosure are used interchangeably to refer to an individual, an entity, or a tool that may request or order a service. Also, the term “driver,” “provider,” and “service provider” in the present disclosure are used interchangeably to refer to an individual, an entity, or a tool that may provide a service or facilitate the providing of the service.

The term “service request,” “request for a service,” “requests,” and “order” in the present disclosure are used interchangeably to refer to a request that may be initiated by a passenger, a service requester, a customer, a driver, a provider, a service provider, or the like, or any combination thereof. The service request may be accepted by any one of a passenger, a service requester, a customer, a driver, a provider, or a service provider. The service request may be chargeable or free.

The term “service provider terminal” and “driver terminal” in the present disclosure are used interchangeably to refer to a mobile terminal that is used by a service provider to provide a service or facilitate the providing of the service. The term “service requester terminal” and “passenger terminal” in the present disclosure are used interchangeably to refer to a mobile terminal that is used by a service requester to request or order a service.

The positioning technology used in the present disclosure may be based on a global positioning system (GPS), a global navigation satellite system (GLONASS), a compass navigation system (COMPASS), a Galileo positioning system, a quasi-zenith satellite system (QZSS), a wireless fidelity (WiFi) positioning technology, or the like, or any combination thereof. One or more of the above positioning systems may be used interchangeably in the present disclosure.

An aspect of the present disclosure relates to systems and methods for dividing an area in an online O2O service system. The area may include a service area where service providers may provide an O2O service. In the online O2O service system, a large area may be divided into a plurality of sub-areas to improve the operation efficiency of the online O2O service system. For example, the large area may be divided into sub-areas according to the amount of service resources (e.g., the number of service providers). The service resources in a sub-area with surplus service resources may be redistributed to a sub-area with insufficient service resources, and thereby the service resources can be distributed more efficiently in the online O2O service system.

In some embodiments, the area division may be performed based on a predicted value of an indicator. The indicator may be associated with the service demand, the service supply, or a demand-supply gap, or the like. A plurality of preliminary target sub-areas may be determined from a plurality of sub-areas that make up the area. For each preliminary target sub-area, a predicted value of the indicator may be determined based on one or more features related to the preliminary target sub-area and a trained model. The area may be re-divided into a plurality of target sub-areas based on the predicted values of the indicator of the preliminary target sub-areas. For example, one or more preliminary sub-areas with similar predicted values of the indicator may be integrated into a target sub-area. As such, the area may be divided efficiently and accurately, which may serve as a basis for, such as resource redistribution and price setting in the online O2O service system.

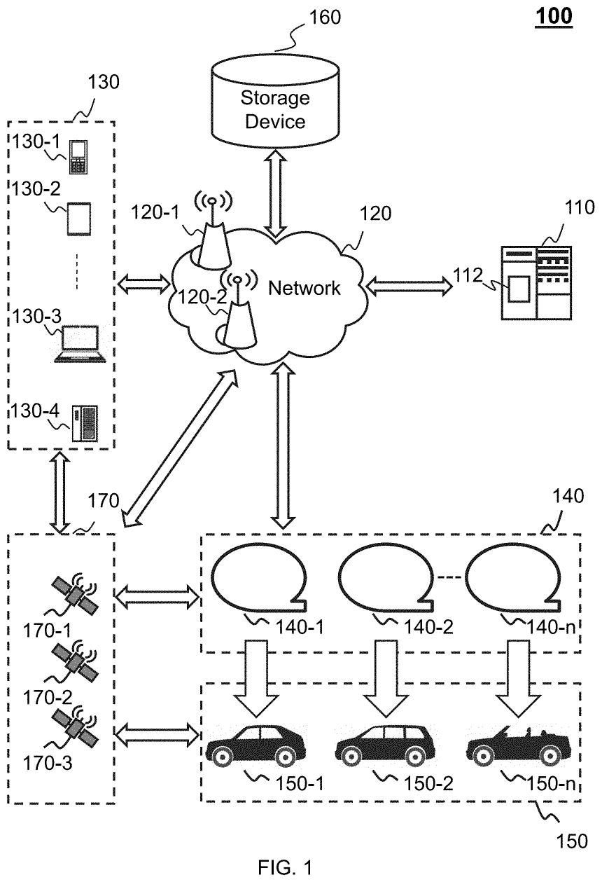

FIG. 1 is a block diagram illustrating an exemplary O2O service system 100 according to some embodiments of the present disclosure. For example, the O2O service system 100 may be an online transportation service platform for transportation services. The O2O service system 100 may include a server 110, a network 120, a service requester terminal 130, a service provider terminal 140, a vehicle 150, a storage device 160, and a navigation system 170.

The O2O service system 100 may provide a plurality of services. Exemplary service may include a taxi-hailing service, a chauffeur service, an express car service, a carpool service, a bus service, a driver hire service, and a shuttle service. In some embodiments, the O2O service may be any on-line service, such as booking a meal, shopping, or the like, or any combination thereof.

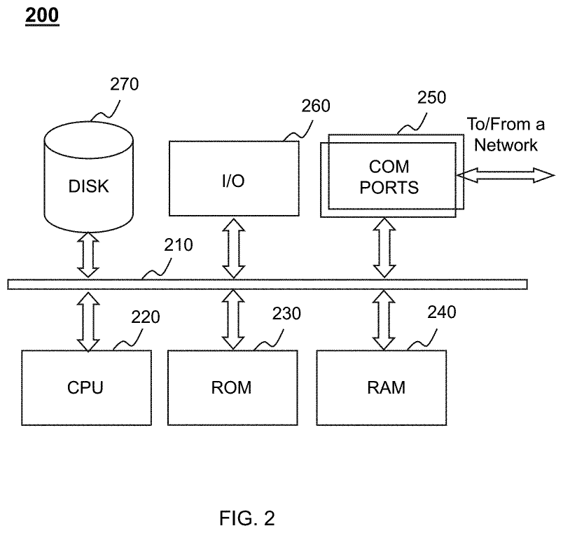

In some embodiments, the server 110 may be a single server or a server group. The server group may be centralized, or distributed (e.g., the server 110 may be a distributed system). In some embodiments, the server 110 may be local or remote. For example, the server 110 may access information and/or data stored in the service requester terminal 130, the service provider terminal 140, and/or the storage device 160 via the network 120. As another example, the server 110 may be directly connected to the service requester terminal 130, the service provider terminal 140, and/or the storage device 160 to access stored information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device 200 having one or more components illustrated in FIG. 2 in the present disclosure.

In some embodiments, the server 110 may include a processing engine 112. The processing engine 112 may process information and/or data related to the service request to perform one or more functions described in the present disclosure. For example, the processing engine 112 may determine one or more candidate service provider terminals in response to the service request received from the service requester terminal 130. In some embodiments, the processing engine 112 may include one or more processing engines (e.g., single-core processing engine(s) or multi-core processor(s)). Merely by way of example, the processing engine 112 may include a central processing unit (CPU), an application-specific integrated circuit (ASIC), an application-specific instruction-set processor (ASIP), a graphics processing unit (GPU), a physics processing unit (PPU), a digital signal processor (DSP), a field-programmable gate array (FPGA), a programmable logic device (PLD), a controller, a microcontroller unit, a reduced instruction-set computer (RISC), a microprocessor, or the like, or any combination thereof.

The network 120 may facilitate exchange of information and/or data. In some embodiments, one or more components of the O2O service system 100 (e.g., the server 110, the service requester terminal 130, the service provider terminal 140, the vehicle 150, the storage device 160, and the navigation system 170) may transmit information and/or data to other component(s) of the O2O service system 100 via the network 120. For example, the server 110 may receive a service request from the service requester terminal 130 via the network 120. In some embodiments, the network 120 may be any type of wired or wireless network, or combination thereof. Merely by way of example, the network 120 may include a cable network, a wireline network, an optical fiber network, a telecommunications network, an intranet, an Internet, a local area network (LAN), a wide area network (WAN), a wireless local area network (WLAN), a metropolitan area network (MAN), a wide area network (WAN), a public telephone switched network (PSTN), a Bluetooth network, a ZigBee network, a near field communication (NFC) network, or the like, or any combination thereof. In some embodiments, the network 120 may include one or more network access points. For example, the network 120 may include wired or wireless network access points such as base stations and/or internet exchange points 120-1, 120-2, . . . , through which one or more components of the O2O service system 100 may be connected to the network 120 to exchange data and/or information.

In some embodiments, a passenger may be an owner of the service requester terminal 130. In some embodiments, the owner of the service requester terminal 130 may be someone other than the passenger. For example, an owner A of the service requester terminal 130 may use the service requester terminal 130 to transmit a service request for a passenger B or receive a service confirmation and/or information or instructions from the server 110. In some embodiments, a service provider may be a user of the service provider terminal 140. In some embodiments, the user of the service provider terminal 140 may be someone other than the service provider. For example, a user C of the service provider terminal 140 may use the service provider terminal 140 to receive a service request for a service provider D, and/or information or instructions from the server 110. In some embodiments, “passenger” and “passenger terminal” may be used interchangeably, and “service provider” and “service provider terminal” may be used interchangeably. In some embodiments, the service provider terminal may be associated with one or more service providers (e.g., a night-shift service provider, or a day-shift service provider).

In some embodiments, the service requester terminal 130 may include a mobile device 130-1, a tablet computer 130-2, a laptop computer 130-3, a built-in device in a vehicle 130-4, or the like, or any combination thereof. In some embodiments, the mobile device 130-1 may include a smart home device, a wearable device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a smart bracelet, a smart footgear, smart glasses, a smart helmet, a smart watch, smart clothing, a smart backpack, a smart accessory, or the like, or any combination thereof. In some embodiments, the smart mobile device may include a smartphone, a personal digital assistance (PDA), a gaming device, a navigation device, a point of sale (POS) device, or the like, or any combination thereof. In some embodiments, the virtual reality device and/or the augmented reality device may include a virtual reality helmet, a virtual reality glass, a virtual reality patch, an augmented reality helmet, augmented reality glasses, an augmented reality patch, or the like, or any combination thereof. For example, the virtual reality device and/or the augmented reality device may include a Google™ Glass, an Oculus Rift, a HoloLens, a Gear VR, etc. In some embodiments, the built-in device in the vehicle 130-4 may include an onboard computer, an onboard television, etc. In some embodiments, the service requester terminal 130 may be a device with positioning technology for locating the position of the passenger and/or the service requester terminal 130.

The service provider terminal 140 may include a plurality of service provider terminals 140-1, 140-2, . . . , 140-n. In some embodiments, the service provider terminal 140 may be similar to, or the same device as the service requester terminal 130. In some embodiments, the service provider terminal 140 may be customized to be able to implement the online on-demand transportation service. In some embodiments, the service provider terminal 140 may be a device with positioning technology for locating the service provider, the service provider terminal 140, and/or a vehicle 150 associated with the service provider terminal 140. In some embodiments, the service requester terminal 130 and/or the service provider terminal 140 may communicate with another positioning device to determine the position of the passenger, the service requester terminal 130, the service provider, and/or the service provider terminal 140. In some embodiments, the service requester terminal 130 and/or the service provider terminal 140 may periodically transmit the positioning information to the server 110. In some embodiments, the service provider terminal 140 may also periodically transmit the availability status to the server 110. The availability status may indicate whether a vehicle 150 associated with the service provider terminal 140 is available to carry a passenger. For example, the service requester terminal 130 and/or the service provider terminal 140 may transmit the positioning information and the availability status to the server 110 every thirty minutes. As another example, the service requester terminal 130 and/or the service provider terminal 140 may transmit the positioning information and the availability status to the server 110 each time the user logs into the mobile application associated with the online on-demand transportation service.

In some embodiments, the service provider terminal 140 may correspond to one or more vehicles 150. The vehicles 150 may carry the passenger and travel to the destination. The vehicles 150 may include a plurality of vehicles 150-1, 150-2, . . . , 150-n. One vehicle may correspond to one type of services (e.g., a taxi-hailing service, a chauffeur service, an express car service, a carpool service, a bus service, a driver hire service, or a shuttle service).

The storage device 160 may store data and/or instructions. In some embodiments, the storage device 160 may store data obtained from the service requester terminal 130 and/or the service provider terminal 140. In some embodiments, the storage device 160 may store data and/or instructions that the server 110 may execute or use to perform exemplary methods described in the present disclosure. In some embodiments, storage device 160 may include a mass storage, removable storage, a volatile read-and-write memory, a read-only memory (ROM), or the like, or any combination thereof. Exemplary mass storage may include a magnetic disk, an optical disk, solid-state drives, etc. Exemplary removable storage may include a flash drive, a floppy disk, an optical disk, a memory card, a zip disk, a magnetic tape, etc. Exemplary volatile read-and-write memory may include a random-access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (EPROM), an electrically-erasable programmable ROM (EEPROM), a compact disk ROM (CD-ROM), and a digital versatile disk ROM, etc. In some embodiments, the storage device 160 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage device 160 may be connected to the network 120 to communicate with one or more components of the O2O service system 100 (e.g., the server 110, the service requester terminal 130, or the service provider terminal 140). One or more components of the O2O service system 100 may access the data or instructions stored in the storage device 160 via the network 120. In some embodiments, the storage device 160 may be directly connected to or communicate with one or more components of the O2O service system 100 (e.g., the server 110, the service requester terminal 130, the service provider terminal 140). In some embodiments, the storage device 160 may be part of the server 110.

The navigation system 170 may determine information associated with an object, for example, one or more of the service requester terminal 130, the service provider terminal 140, the vehicle 150, etc. In some embodiments, the navigation system 170 may be a global positioning system (GPS), a global navigation satellite system (GLONASS), a compass navigation system (COMPASS), a BeiDou navigation satellite system, a Galileo positioning system, a quasi-zenith satellite system (QZSS), etc. The information may include a location, an elevation, a velocity, or an acceleration of the object, or a current time. The navigation system 170 may include one or more satellites, for example, a satellite 170-1, a satellite 170-2, and a satellite 170-3. The satellites 170-1 through 170-3 may determine the information mentioned above independently or jointly. The satellite navigation system 170 may transmit the information mentioned above to the network 120, the service requester terminal 130, the service provider terminal 140, or the vehicle 150 via wireless connections.

In some embodiments, one or more components of the O2O service system 100 (e.g., the server 110, the service requester terminal 130, the service provider terminal 140) may have permissions to access the storage device 160. In some embodiments, one or more components of the O2O service system 100 may read and/or modify information related to the passenger, service provider, and/or the public when one or more conditions are met. For example, the server 110 may read and/or modify one or more passengers' information after a service is completed. As another example, the server 110 may read and/or modify one or more service providers' information after a service is completed.

In some embodiments, information exchanging of one or more components of the O2O service system 100 may be initiated by way of requesting a service. The object of the service request may be any product. In some embodiments, the product may include food, medicine, commodity, chemical product, electrical appliance, clothing, car, housing, luxury, or the like, or any combination thereof. In some other embodiments, the product may include a servicing product, a financial product, a knowledge product, an internet product, or the like, or any combination thereof. The internet product may include an individual host product, a web product, a mobile internet product, a commercial host product, an embedded product, or the like, or any combination thereof. The mobile internet product may be used in a software of a mobile terminal, a program, a system, or the like, or any combination thereof. The mobile terminal may include a tablet computer, a laptop computer, a mobile phone, a personal digital assistance (PDA), a smart watch, a point of sale (POS) device, an onboard computer, an onboard television, a wearable device, or the like, or any combination thereof. For example, the product may be any software and/or application used on the computer or mobile phone. The software and/or application may relate to socializing, shopping, transporting, entertainment, learning, investment, or the like, or any combination thereof. In some embodiments, the software and/or application related to transporting may include a traveling software and/or application, a vehicle scheduling software and/or application, a mapping software and/or application, etc. In the vehicle scheduling software and/or application, the vehicle may include a horse, a carriage, a rickshaw (e.g., a wheelbarrow, a bike, a tricycle, etc.), a car (e.g., a taxi, a bus, a private car, etc.), a train, a subway, a vessel, an aircraft (e.g., an airplane, a helicopter, a space shuttle, a rocket, a hot-air balloon, etc.), or the like, or any combination thereof.

One of ordinary skill in the art would understand that when an element (or component) of the O2O service system 100 performs, the element may perform through electrical signals and/or electromagnetic signals. For example, when a service requester terminal 130 transmits out a service request to the server 110, a processor of the service requester terminal 130 may generate an electrical signal encoding the request. The processor of the service requester terminal 130 may then transmit the electrical signal to an output port. If the service requester terminal 130 communicates with the server 110 via a wired network, the output port may be physically connected to a cable, which further may transmit the electrical signal to an input port of the server 110. If the service requester terminal 130 communicates with the server 110 via a wireless network, the output port of the service requester terminal 130 may be one or more antennas, which convert the electrical signal to electromagnetic signal. Similarly, a service provider terminal 130 may receive an instruction and/or service request from the server 110 via electrical signal or electromagnet signals. Within an electronic device, such as the service requester terminal 130, the service provider terminal 140, and/or the server 110, when a processor thereof processes an instruction, transmits out an instruction, and/or performs an action, the instruction and/or action is conducted via electrical signals. For example, when the processor retrieves or saves data from a storage medium, it may transmit out electrical signals to a read/write device of the storage medium, which may read or write structured data in the storage medium. The structured data may be transmitted to the processor in the form of electrical signals via a bus of the electronic device. Here, an electrical signal may refer to one electrical signal, a series of electrical signals, and/or a plurality of discrete electrical signals.

FIG. 2 is a schematic diagram illustrating exemplary hardware and software components of a computing device 200 on which the server 110, the service requester terminal 130, and/or the service provider terminal 140 may be implemented according to some embodiments of the present disclosure. For example, the processing engine 112 may be implemented on the computing device 200 and configured to perform functions of the processing engine 112 disclosed in this disclosure.

The computing device 200 may be a special purpose computer in some embodiments. The computing device 200 may be used to implement an O2O system for the present disclosure. The computing device 200 may implement any component of the O2O service as described herein. In FIGS. 1-2, only one such computer device is shown purely for convenience purposes. One of ordinary skill in the art would understood at the time of filing of this application that the computer functions relating to the O2O service as described herein may be implemented in a distributed fashion on a number of similar platforms, to distribute the processing load.

The computing device 200, for example, may include COM ports 250 connected to and from a network connected thereto to facilitate data communications. The computing device 200 may also include a central processing unit (CPU, or processor) 220, in the form of one or more processors, for executing program instructions. The exemplary computer platform may include an internal communication bus 210, a program storage and a data storage of different forms, for example, a disk 270, and a read only memory (ROM) 230, or a random access memory (RAM) 240, for various data files to be processed and/or transmitted by the computer. The exemplary computer platform may also include program instructions stored in the ROM 230, the RAM 240, and/or other type of non-transitory storage medium to be executed by the CPU/processor 220. The methods and/or processes of the present disclosure may be implemented as the program instructions. The computing device 200 may also include an I/O component 260, supporting input/output between the computer and other components therein such as a user interface element 280. The computing device 200 may also receive programming and data via network communications.

Merely for illustration, only one CPU/processor 220 is described in the computing device 200. However, it should be note that the computing device 200 in the present disclosure may also include multiple CPUs/processors, thus operations and/or method steps that are performed by one CPU/processor 220 as described in the present disclosure may also be jointly or separately performed by the multiple CPUs/processors. For example, if in the present disclosure the CPU/processor 220 of the computing device 200 executes both step A and step B, it should be understood that step A and step B may also be performed by two different CPUs/processors jointly or separately in the computing device 200 (e.g., the first processor executes step A and the second processor executes step B, or the first and second processors jointly execute steps A and B).

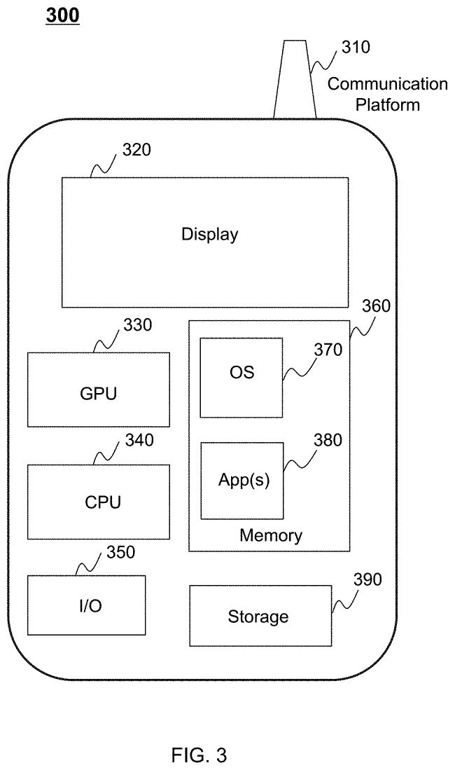

FIG. 3 is a schematic diagram illustrating exemplary hardware and/or software components of an exemplary mobile device 300 on which a use terminal may be implemented according to some embodiments of the present disclosure. As illustrated in FIG. 3, the mobile device 300 may include a communication platform 310, a display 320, a graphic processing unit (GPU) 330, a central processing unit (CPU) 340, an I/O 350, a memory 360, and a storage 390. In some embodiments, any other suitable component, including but not limited to a system bus or a controller (not shown), may also be included in the mobile device 300. In some embodiments, a mobile operating system 370 (e.g., iOS™, Android™, Windows Phone™, etc.) and one or more applications 380 may be loaded into the memory 360 from the storage 390 in order to be executed by the CPU 340. The applications 380 may include a browser or any other suitable mobile apps for receiving and rendering information relating to image processing or other information from the processing engine 112. User interactions with the information stream may be achieved via the I/O 350 and provided to the processing engine 112 and/or other components of the O2O service system 100 via the network 120.

To implement various modules, units, and their functionalities described in the present disclosure, computer hardware platforms may be used as the hardware platform(s) for one or more of the elements described herein. A computer with user interface elements may be used to implement a personal computer (PC) or any other type of work station or terminal device. A computer may also act as a server if appropriately programmed.

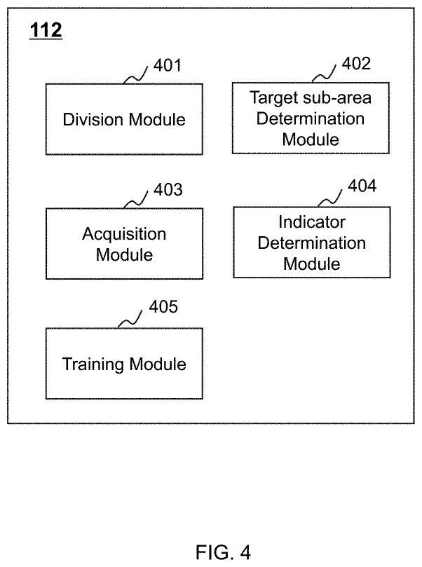

FIG. 4 is a block diagram illustrating an exemplary processing engine 112 according to some embodiments of the present disclosure. The processing engine 112 may include a division module 401, a target sub-area determination module 402, an acquisition module 403, an indicator determination module 404, and a training module 405. Each module may be a hardware circuit that is designed to perform certain actions, e.g. according to a set of instructions stored in one or more storage media, and/or any combination of the hardware circuit and the one or more storage media.

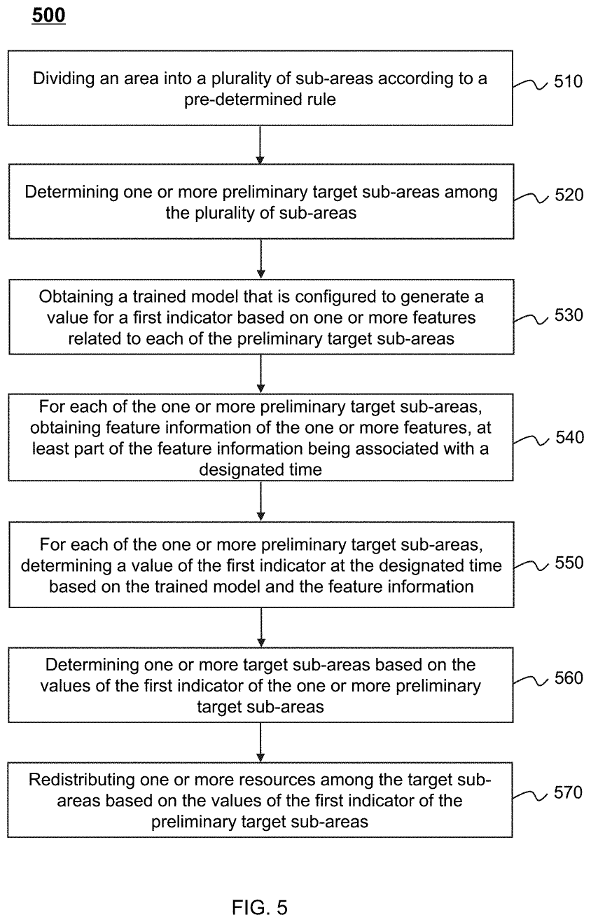

The division module 401 may be configured to divide an area into a plurality of sub-areas. The area to be divided may be any administrative area, such as but not limited to a country, a province, a city, or a district. In some embodiments, the area to be divided may be a service area where service providers may provide an O2O service. In some embodiments, the division module 401 may divide the area randomly. Additionally and/or alternatively, the division module 401 may divide the area according to a predetermined rule. In some embodiments, the predetermined rule may use parameters, such as but not limited to a size of area, a density of population, a division of administrative area, a density of office buildings, a density of residential buildings, longitudinal and latitudinal coordinates, a total length of paved road, a total length of highway, or the like, or any combination thereof. The predetermined rule may be set manually or be determined by one or more components of the O2O service system 100 (e.g., the division module 401) according to different situations. Details regarding the division of the area may be found elsewhere in the present disclosure (e.g., FIG. 5 and the related descriptions thereof).

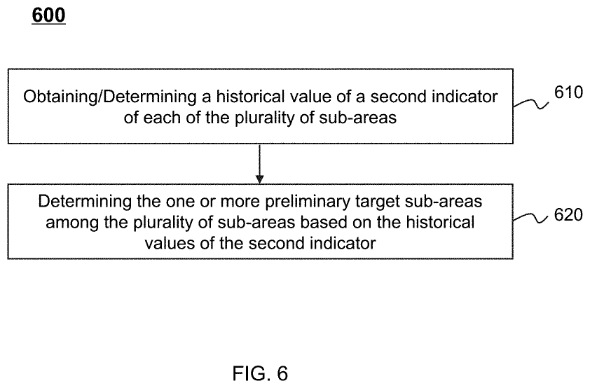

The target sub-area determination module 402 may be configured to determine one or more preliminary target sub-areas among the plurality of sub-areas. In some embodiments, the target sub-area determination module 402 may select the preliminary target sub-areas among the sub-areas randomly or according to one or more selection criteria. In some embodiments, the selection criteria may include but not be limited to a historical value of a second indicator (e.g., a number of service orders, a number of service providers, a number of service requesters, a number of filled service requests, a number of un-filled service requests, a difference between the number of service providers and service requesters) of each sub-area. For example, the target sub-area determination module 402 may determine whether the historical value of the second indicator of a sub-area exceeds a first threshold. Upon a determination that the historical value of the second indicator of the sub-area exceeds the first threshold, the target sub-area determination module 402 may designate the sub-area as a preliminary target sub-area. Details regarding the determination of the preliminary target sub-areas may be found elsewhere in the present disclosure (e.g., FIGS. 5 and 6 and the related descriptions thereof).

Additionally and/or alternatively, the target sub-area determination module 402 may be configured to determine one or more target sub-areas based on a value of a first indicator of each of the preliminary target sub-areas. The first indicator may be any parameter that is associated with the O2O service that is being provided in the area (or the preliminary target sub-area). For example, the first indicator may be associated with the service supply, the service demand, or the demand-supply gap in a preliminary target sub-area. In some embodiments, the target sub-area determination module 402 may determine a target sub-area by integrating one or more preliminary target sub-areas who have similar values of the first indicator into the target sub-area. Details regarding the determination of the target sub-areas may be found elsewhere in the present disclosure (e.g., FIG. 5 and the related descriptions thereof).

The acquisition module 403 may be configured to obtain information related to the O2O service system 100. In some embodiments, the acquisition module 403 may obtain information related to an area, a subarea of the area, a preliminary target sub-area, or a target sub-area as described elsewhere in this disclosure. For example, the acquisition module 403 may obtain feature information of the one or more features related to a preliminary target sub-area. The features may include but not be limited to time, location, weather, traffic, policy, news, road condition, service order, service requester, or service provider, or the like, or any combination thereof. The feature information of the features may include but not be limited to time information, location information, weather information, traffic information, policy information, news information, road condition information, service order information, service requester information, service provider information, or the like, or any combination thereof. As another example, the acquisition module 403 may obtain and/or determine a historical value of a second indicator of a sub-area. The second indicator may include a size, a population density, a building density, a number of service orders, a number of service providers, a number of service requesters, a difference between the number of service providers and the number of service requesters, a density of residential buildings, a longitudinal and latitudinal coordinates, a total length of paved road, a total length of highway, or the like, or any combination thereof.

In some embodiments, the acquisition module 403 may obtain a trained model related to the first indicator. In certain embodiments, the trained model may include a decision tree model, a random forest model, a logistic regression model, a support vector machine (SVM) model, a Naive Bayesian model, a K-nearest neighbor model, a K-means model, an AdaBoost model, a Neural Networks model, a Markov Chains model, or the like, or any combination thereof.

In some embodiments, the acquisition module 403 may obtain information related to the O2O service system 100 from one or more components in the O2O service system 100, such as a storage device (e.g., the storage device 160), or user terminals (e.g., the service requester terminal 130, the service provider terminal 140). Additionally and/or alternatively, the acquisition module 403 may obtain information related to the O2O service system 100 from another system via the network 120 (e.g., a weather condition platform, a traffic guidance platform, a traffic radio platform, a policy platform, a government channel, a news platform, and/or any other system).

The indicator determination module 404 may be configured to determine a value of the first indicator of an area, a subarea of the area, a preliminary target sub-area, or a target sub-area at a designated time. In some embodiments, the indicator determination module 404 may determine the value of the first indicator of a preliminary target sub-area based on the trained model related to the first indicator and the feature information of one or more features of the preliminary target sub-area. In some embodiments, the indicator determination module 404 may determine the value of the first indicator of the preliminary target sub-area by inputting the feature information of the preliminary target sub-area into the trained model.

The training module 405 may be configured to train a model related to an indicator. In some embodiments, the trained model may include a decision tree model, a random forest model, a logistic regression model, a support vector machine (SVM) model, a Naive Bayesian model, a K-nearest-neighbor model, a K-means model, an AdaBoost model, a Neural Networks model, a Markov Chains model, or the like, or any combination thereof. In some embodiments, the training module 405 may train the model related to the indicator based on a machine learning algorithm (e.g., an artificial neural networks algorithm, a deep learning algorithm, a decision tree algorithm, an association rule algorithm, an inductive logic programming algorithm).

Additionally and/or alternatively, the training module 405 may further validate a model (or trained model) related to the indicator. For example, the training module 405 may train and validate the model (or trained model) based on a cross-validation method. The cross-validation method may include but not be limited to an exhaustive cross-validation method, a leave-p-out cross-validation method, a leave-one-out cross-validation method, a k-fold cross-validation method, a Holdout method, a repeated random sub-sampling validation method, or the like.

In some embodiments, the training module 405 may train a model related to the first indicator as described elsewhere in this disclosure. The trained model related to the first indicator may be used to determine the value of the first indicator of a preliminary sub-area. In some embodiments, the training module 405 may train the model related to the first indicator based on a loss of function (e.g., a difference between a predicted value and a historical value of the first indicator). Additionally and/or alternatively, the training module 405 may validate the trained model related to the first indicator. In some embodiments, the training module 405 may validate the trained model related to the first indicator based on a validation parameter of the trained model. The validation parameter may include but not be limited to a precision, a recall, an F-score, a confusion matrix, a Receiver Operating Characteristic (ROC), Area under Curve (AUC), a variance, or the like.

It should be noted that the above descriptions of the processing engine 112 is provided for the purposes of illustration, and not intended to limit the scope of the present disclosure. For persons having ordinary skills in the art, various modifications and changes in the forms and details of the application of the above method and system may occur without departing from the principles of the present disclosure. However, those variations and modifications also fall within the scope of the present disclosure. In some embodiments, the processing engine 112 may include one or more other modules. For example, the processing engine 112 may include a storage module to store data generated by the modules in the processing engine 112. In some embodiments, any two of the modules may be combined as a single module, and any one of the modules may be divided into two or more units.

FIG. 5 is a flowchart illustrating an exemplary process for dividing an area based on an indicator according to some embodiments of the present disclosure. Process 500 may be executed by the O2O service system 100. For example, the process 500 may be implemented as a set of instructions (e.g., an application) stored in storage device 160. In some embodiments, the processing engine 112 may execute the set of instructions and may accordingly be directed to perform the process 500 in an O2O service platform. The platform may be an Internet-based platform that connects service providers and requesters through the Internet.

In 510, the processing engine 112 (e.g., the division module 401) may divide an area into a plurality of sub-areas according to a predetermined rule. The area to be divided may be any administrative area, such as but not limited to a country, a province, a city, or a district. The area may be an area in any location. In some embodiments, the area may be a service area where service providers may provide an O2O service. In some embodiments, the area may be large enough that, when divided, the sub-areas may have variations as to certain indicators related to the O2O service. In some embodiments, the O2O service may be a transportation service (for example, a taxi hailing service, a chauffeur service, an express car service, a carpool service, a bus service, a driver hire service, and a shuttle service), a post service, or a food order service, or the like, or any combination thereof.

In some embodiments, the predetermined rule may use parameters such as but not limited to a size of area, a density of population, a division of administrative area, a density of office buildings, a density of residential buildings, longitudinal and latitudinal coordinates, a total length of paved road, a total length of highway, or the like, or any combination thereof. In some embodiments, the predetermined rule may utilize an even division as applied to the parameter. For example, the division module 401 may divide the area into sub-areas with the same size. As another example, the division module 401 may divide the area into sub-areas each of which has similar density of office buildings or population. As a further example, the division module 401 may divide the area into sub-areas each of which has similar length of paved road or highway. The predetermined rule may be set manually or be determined by one or more components of the O2O service system 100 (e.g., the division module 401) according to different situations.

The sub-areas may be any size or shape. The shapes and/or sizes of different sub-areas may be same or different. In some embodiments, the division module 401 may divide the area into a plurality of sub-areas with the same size and shape. For example, the division module 401 may uniformly divide the area into a plurality of sub-areas having a polygonal shape, such as a regular triangle, a rectangle, a square, or a regular hexagon.

In 520, the processing engine 112 (e.g., the target sub-area determination module 402) may determine one or more preliminary target sub-areas among the plurality of sub-areas. In some embodiments, the target sub-area determination module 402 may select the preliminary target sub-areas among the sub-areas randomly or according to one or more selection criteria. In some embodiments, the selection criteria may include but not be limited to a historical value of a second indicator (e.g., a number of service orders, a number of service providers, a number of service requesters, a number of filled service requests, a number of un-filled service requests, a difference between the number of service providers and service requesters) of each sub-area. More descriptions regarding the determination of the preliminary target sub-areas may be found elsewhere in the present disclosure (e.g., FIG. 6 and the related descriptions).

In 530, the processing engine 112 (e.g., the acquisition module 403) may obtain a trained model related to a first indicator. The first indicator may be any parameter that is associated with the O2O service that is being provided in the area. For example, the first indicator may be associated with the service supply, the service demand, the demand-supply gap, or the like. Taking the taxi hailing service as an example, the first indicator may include a number of drivers, a number of passengers, a number of service orders, a number of service requests, a difference between the number of drivers and the number of passengers, or the like, or any combination thereof.

In some embodiments, the trained model related to the first indicator may be configured to generate a value of the first indicator based on one or more features related to each of the preliminary target sub-areas. In certain embodiments, the trained model may include a decision tree model, a random forest model, a logistic regression model, a support vector machine (SVM) model, a Naive Bayesian model, a K-nearest-neighbor model, a K-means model, an AdaBoost model, a Neural Networks model, a Markov Chains model, or the like, or any combination thereof. The acquisition module 403 may obtain the trained model related to the first indicator from a storage device in the O2O service system 100 (e.g., the storage device 160) and/or an external data source (not shown) via the Network 120. In some embodiments, the training module 405 may produce the trained model related to the first indicator, and store it in the storage device. The acquisition module 403 may access the storage device and retrieve the trained model related to the first indicator.

In some embodiments, the training module 405 may train a model related to the first indicator based on a machine learning method. The machine learning method may include but not be limited to an artificial neural networks algorithm, a deep learning algorithm, a decision tree algorithm, an association rule algorithm, an inductive logic programming algorithm, a support vector machines algorithm, a clustering algorithm, a Bayesian networks algorithm, a reinforcement learning algorithm, a representation learning algorithm, a similarity and metric learning algorithm, a sparse dictionary learning algorithm, a genetic algorithms, a rule-based machine learning algorithm, or the like, or any combination thereof.

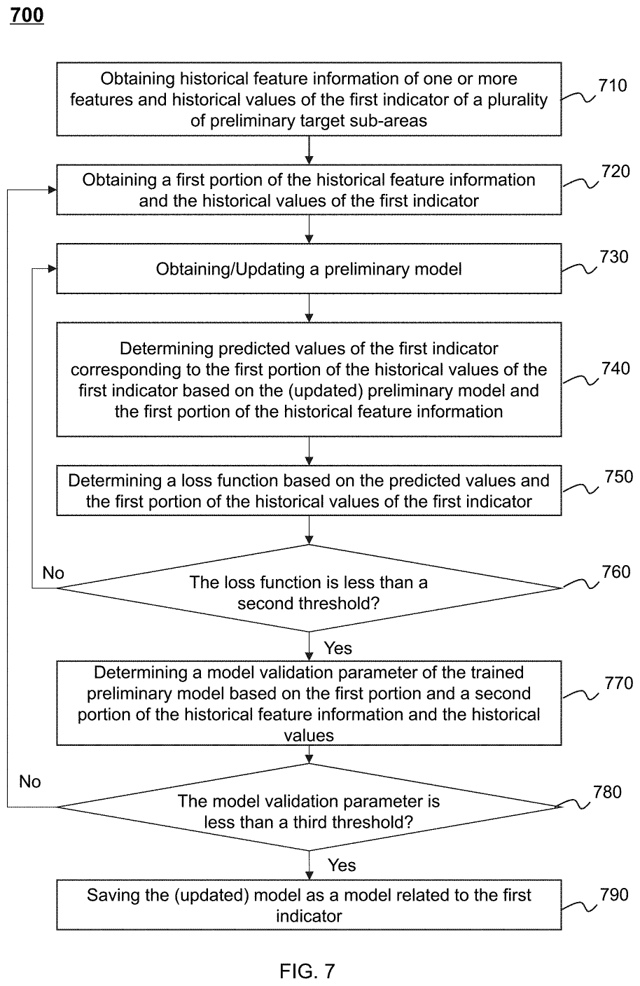

Additionally and/or alternatively, the training module 405 may further validate a model (or trained model) related to the first indicator. For example, the training module 405 may train and validate the model (or trained model) based on a cross-validation method. The cross-validation method may include but not be limited to an exhaustive cross-validation method, a leave-p-out cross-validation method, a leave-one-out cross-validation method, a k-fold cross-validation method, a Holdout method, a repeated random sub-sampling validation method, or the like. More descriptions regarding the training and/or the validation of a model (or trained model) related to the first indicator may be found elsewhere in the present disclosure (e.g., FIG. 7 and the related descriptions).

In 540, the processing engine 112 (e.g., the acquisition module 403) may obtain feature information of the one or more features related to each of the preliminary target sub-areas. In some embodiments, at least part of the feature information may be associated with a designated time. In certain embodiments, the feature information of the features related to a preliminary target sub-area may be used to determine the value of the first indicator of the preliminary target sub-area at the designated time. The value of the first indicator, in turn, may be used to determine whether the preliminary target sub-area may be considered as a target sub-area.

In some embodiments, the features may include but not be limited to time, location, weather, traffic, policy, news, road condition, service order, service requester, or service provider, or the like, or any combination thereof. The feature of the time may be associated with the designated time. The feature of the location, weather, traffic, policy, news, road condition, service order, service requester, or service provider may be associated with the preliminary target sub-area. Accordingly, the feature information of the features may include but not be limited to time information, location information, weather information, traffic information, policy information, news information, road condition information, service order information, service requester information, service provider information, or the like, or any combination thereof.

In some embodiments, the time information may include but not be limited to the date of the designated time, a specific date section (e.g., a weekday, a weekend, a holiday, a festival) of the designated time, a time interval (e.g., in the rush hour, in daytime, at evening) of the designate time, or the like, or any combination thereof. In some embodiments, the location information of a preliminary target sub-area may include but not be limited to a density of office buildings, the latitude and/or the longitude of one or more locations in the preliminary target sub-area (e.g., the center of the preliminary target sub-area), types of one or more locations of interest (LOIs) in the preliminary target sub-area. The types of LOIs may include but not be limited to a public transportation terminal (e.g., subway station, bus stop), a residential area, an office building, a railway station, or a shopping mall.

In some embodiments, the weather information may include but not be limited to an index of air quality, a temperature, a visibility, a humidity, a pressure, a wind speed, an index of PM 2.5, an amount of precipitation, a type of precipitation (e.g., snow, rain), a percentage likelihood of precipitation, or the like, or any combination thereof. The weather information may be real-time weather information, substantially real-time weather information, historical weather information, or weather forecast information. In some embodiments, the traffic information may include but not be limited to a traffic volume, a traffic congestion condition, a number of traffic accidents and their locations, a vehicle speed (e.g., an average speed, an instantaneous speed) information, or the like, or any combination thereof. In some embodiments, the vehicle speed may include a speed of all the vehicles in the preliminary target sub-area, a speed of the vehicles driven into the preliminary target sub-area and/or a speed of the vehicles driven away from the preliminary target sub-area. In some embodiments, the policy information may include but not be limited to laws and rules in the area and/or the sub-area, wherein such laws and rules include but are not limited to laws and rules related to traffic, to vehicle management (e.g., only vehicles with certain plate numbers (e.g., even or odd) can be driven in certain areas), and to speed limits. In some embodiments, the news information may include but not be limited to information and/or a number of events (e.g., a concert, an exhibition, a competition, a market promotion) in the preliminary target sub-area. In some embodiments, the road condition information may include but not be limited to information related to construction and/or repair work on the road and closure of certain roads.

The service order information may include but not be limited to a number of order requests, a number of order requests accepted by service providers, a number of order requests not accepted by service providers, a number of service order canceled by service requesters, a number of service order completed by service providers, an order acceptance rate, an order cancellation rate, an average service order response time, an average distance between the service providers and the pick-up locations, a ranking of a preliminary target sub-area among all the preliminary target sub-areas with respect to the number of service orders, or the like, or any combination thereof.

The service provider information may include but not be limited to a number of service providers in the process of providing service, a number of service providers waiting for a service order, a number of service providers out of service, an average performance score evaluated by passengers, clustering information of service providers (the level of service providers to be clustered into one or a few of locations in the preliminary target sub-area), or the like, or any combination thereof.

The service requester information may include a number of potential service requesters (people who are registered), a number of service requesters whose requests are pending, a number of service requesters who log into an mobile application associated with the O2O service, a number of service requesters who make a service request, preference information of service requesters, or the like, or any combination thereof.

In some embodiments, the designated time may include but not be limited to a designated time point, a designated time interval (e.g., rush hours, day-time), a designated date section (e.g., a weekday, a weekend, a holiday, or a festival), or the like, or any combination thereof. For example, the designated time may be the rush hours (e.g., 8:00 am to 10:00 am) next Monday. As another example, the designated time may be the Christmas day in 2018. As still another example, the designated time may be 12:00 am in Oct. 5^{th,} 2018.

In some embodiments, the designated time may be a time point or a time period with respect to the present moment. For example, the designated time may be 1, 2, 5, 10, 15, 20, 30, or 60 minutes after the present moment. As another example, a day may be divided into a plurality of unit periods. The duration of a unit period may be, for example, 5, 10, 15, 30, or 60 minutes. The designated time may be one or more unit periods after the present moment.

In some embodiments, the acquisition module 403 may obtain at least part of the feature information of a preliminary target sub-area according to the designated time. For example, the acquisition module 403 may obtain weather forecast information, policy information, news information, or road condition information of the preliminary target sub-area associated with the designated time or a time close to the designated time. As another example, the acquisition module 403 may obtain historical traffic information, historical service order information, historical service requester information, or historical service provider information of the preliminary target sub-area at a historical time corresponding to the designated time.

For illustration purpose, in certain embodiments, it is assumed that the designated time is 9:00 am to 10:00 am tomorrow morning. The acquisition module 403 may obtain weather forecast information of the preliminary target sub-area at 9:00 am to 10:00 am tomorrow morning. The acquisition module 403 may also obtain historical traffic information and/or historical service order information at 9:00 am to 10:00 am today or yesterday.

In some embodiments, the designated time may be close to the present moment. For example, the difference between the designated time and the present moment may be less than a threshold, such as 1, 2, 5, 10, 15, 30, or 60 minutes. The feature information associated with the designated time may include feature information at the present moment or a historical time close to the present moment. For example, the acquisition module 403 may obtain the real time weather information, real time traffic condition information. As another example, the acquisition module 403 may obtain service order information in a historical time period close to the present moment, for example, in the past five minutes, ten minutes, or twenty minutes.

The acquisition module 403 may obtain the feature information of the features related to a preliminary target sub-area from one or more components in the O2O service system 100, such as a storage device (e.g., the storage device 160), or user terminals (e.g., the service requester terminal 130, the service provider terminal 140).

Additionally or alternatively, the acquisition module 403 may obtain at least part of the feature information from another system. The another system may include but not be limited to a weather condition platform, a traffic guidance platform, a traffic radio platform, a policy platform, a government channel, a news platform, and/or any other system that may include information associated with the preliminary target sub-areas. For example, the acquisition module 403 may obtain traffic information (e.g., traffic accident information, traffic condition information, traffic restriction information) from a traffic guidance platform. As another example, the acquisition module 403 may obtain weather information (e.g., real-time weather information, substantially real-time weather information, historical weather information, weather forecast information) from a weather forecast website.

In 550, for each of the one or more preliminary target sub-areas, the processing engine 112 (e.g., the indicator determination module 404) may determine a value of the first indicator at the designated time based on the trained model and the feature information. In some embodiments, the indicator determination module 404 may determine a value of the first indicator for a preliminary target sub-area by inputting the feature information of the preliminary target sub-area into the trained model.

In some embodiments, step 550 may be implemented in an electronic device such a smartphone, a personal digital assistant (PDA), a tablet computer, a laptop, a carputer (board computer), a play station portable (PSP), a pair of smart glasses, a smart watch, a wearable devices, a virtual display device, display enhanced equipment (e.g. a Google™ Glass, an Oculus Rift, a HoloLens, or a Gear VR), or the like, or any combination thereof. In certain embodiments, the value of the first indicator may be sent to the server 110 or the computing device where the O2O service platform is implemented.

In 560, the processing engine 112 (e.g., the target sub-area determination module 402) may determine one or more target sub-areas based on the values of the first indicators of each of the preliminary target sub-areas. In some embodiments, a target sub-area may include one or more preliminary target sub-areas who have similar values of the first indicator. In some embodiments, the first indicator may be associated with the service supply, the service demand, or the demand-supply gap in a preliminary target sub-area as described in connection with step 530. Accordingly, the target sub-area may include one or more preliminary target sub-areas that have certain characteristics (e.g., supply and/or demand characteristics) in common.

For example, the target sub-area determination module 402 may integrate one or more preliminary target sub-areas into a target sub-area if their differences between the values of the first indicator are less than a threshold. As another example, the target sub-area determination module 402 may integrate one or more preliminary target areas into a target sub-area if their values of the first indicator are within a certain range. As yet another example, the target sub-area determination module 402 may rank the preliminary target areas and integrate one or more adjacent preliminary target areas into a target sub-area if their differences between the values of the first indicator are less than a threshold.

In some embodiments, the target sub-area determination module 402 may rank the preliminary target sub-areas from, for example, high to low; then the target sub-area determination module 402 may integrate one or more preliminary target sub-areas into various target sub-areas based on their rankings. For example, the target sub-area determination module 402 may integrate the top ⅓ of the preliminary target sub-areas into a first target sub-area, the middle ⅓ of the preliminary target sub-areas into a second target sub-area, and the bottom ⅓ of the preliminary target sub-areas into a third target sub-area.

In some embodiments, the target sub-area determination module 402 may rank the preliminary target sub-areas from, for example, high to low; and then the target sub-area determination module 402 may integrate the top preliminary target sub-areas that surpass a certain percentage threshold of the first indicator value into a target sub-area. For example, the target sub-area determination module 402 may rank the preliminary target sub-areas based on the number of service requests; if the total number of service requests is considered 100% and the percentage threshold is set at 50%, then the target sub-area determination module 402 may integrate the minimum number of top preliminary target sub-areas into a first target sub-area when their combined service requests surpass 50% and may further integrate the rest of the preliminary target sub-areas into a second target sub-area.

In 570, the processing engine 112 may redistribute one or more resources among the target sub-areas based on the values of the first indicator of the preliminary target sub-areas. The resources may be associated with the service that is provided in the target sub-areas (or the preliminary target sub-areas). Taking the taxi hailing service as an example, the resources may include but not be limited to drivers, vehicles, passengers, service orders, and/or the like.

In some embodiments, a target sub-area may include one or more preliminary target sub-areas that have certain characteristics (e.g., supply and/or demand characteristics) in common as described in connection with step 560. In certain embodiments, the resources may be redistributed among the target sub-areas based on its various supply and/or demand characteristics. For example, more resources may be distributed to a target sub-area in which the preliminary target sub-areas have a high demand and/or a short supply. Additionally or alternatively, the resources may be taken away from a target sub-area in which the preliminary target sub-areas have a surplus supply and/or an insufficient demand.

For illustration purposes, the present disclosure takes the taxi hailing service as an example. It is assumed that the first indicator may be a difference between the number of drivers and the number of passengers, and the processing engine 112 may execute steps 510 to 560 to determine a plurality of target sub-areas based on the predicted values of the first indicator in the peak period (e.g., 8:00 to 9:00 am) tomorrow morning. The plurality of target sub-areas may include a first target sub-area with surplus supply (e.g., the number of drivers being much greater than the number of passengers), a second target sub-area with short supply (e.g., the number of the drivers being much smaller than the number of passengers), and a third target sub-area with balanced supply (e.g., the number of the drivers being close to the number of passengers).

As used herein, the “much greater than” may indicate that the difference between the numbers of drivers and passengers is greater than a first value. In certain embodiments, being “much greater than” means at least 5%, 10%, 15%, 20%, 25%, 30%, 35%, 40%, 45%, 50%, 60%, 70%, 80%, 90% or 100% more than the first value. The “much smaller than” may indicate that the difference between the numbers of passengers and drivers is greater than a second value. In certain embodiments, being “much smaller than” means at least 5%, 10%, 15%, 20%, 25%, 30%, 35%, 40%, 45%, 50%, 60%, or 70% less than the second value. The “close to” may indicate that the difference between the numbers of passengers and drivers is smaller than a third value. In certain embodiments, being “close to” means at most 5%, 10%, 15%, 20%, 25%, 30%, 35%, 40%, 45%, or 50% more or less than the third value. The first, second, or third values may be a constant number, or a percentage of the number of drivers or the number of the passengers. In some embodiments, the first, second, or third values may be predetermined by the O2O service system.

In some embodiments, more resources may be distributed to the second target sub-area with short supply, and/or resources may be taken away from the first target sub-area with surplus supply. For example, the processing engine 112 may direct one or more components in the O2O service system 100, such as the COM port 250 to transmit messages to a number of drivers to suggest them to go to the second target sub-area before the peak period tomorrow morning. As another example, the processing engine 112 may allocate a portion of the service orders in the second target sub-area to the drivers in one or more first target sub-areas adjacent to the second target sub-area before and/or during the peak period tomorrow morning.

It should be noted that the above descriptions of process 500 are provided for the purposes of illustration, and not intended to limit the scope of the present disclosure. For persons having ordinary skills in the art, various modifications and changes in the forms and details of the application of the above method and system may occur without departing from the principles in the present disclosure. However, those variations and modifications also fall within the scope of the present disclosure. In some embodiments, one or more steps may be added or omitted. For example, one or more steps of steps 520, 560 and 570 may be omitted. As another example, steps 510 and 520 may be merged into one step. In some embodiments, the order of the steps in process 500 may be changed. For example, steps 530 and 540 may be performed simultaneously or in any order.

In some embodiments, step 570 may be omitted, and the determined values of the first indicator may serve as a basis for area monitoring. For example, when the processing engine 112 detects that one or more target sub-areas have a special supply and/or demand characteristic, it may transmit a message to one or more components of the O2O service system 100 (e.g., the server 110) to indicate the special supply and/or demand characteristic of the target sub-areas.

Additionally or alternatively, the determined values of the first indicator may serve as a basis for price setting. For example, for a target sub-area in which the preliminary target sub-areas have a high demand and/or a short supply, the service price may increase. For a target sub-area in which the preliminary target sub-areas have a surplus supply and/or an insufficient demand, the service price may decrease.

In some embodiments, steps 560 and 570 may be omitted, and the determined values of the first indicator may serve as a basis for analyzing the area, the sub-areas, or the preliminary target sub-areas. For example, the values of the first indicator of the preliminary target sub-areas may be determined. An average (or median) value of first indicator may be determined based on the values of the first indicator of the preliminary target sub-areas. The average (or median) value of the first indicator may indicate the supply and/or demand characteristic of the area. As another example, step 520 may be omitted and the value of the first indicator for each sub-area may be determined. An average (or median) value of first indicator may be determined based on the values of the first indicator of the sub-areas in the area. As yet another example, one or more sub-areas or preliminary target sub-areas may be selected for further analysis if they have special supply and/or demand characteristics.

FIG. 6 is a flowchart illustrating an exemplary process for determining a preliminary target sub-area according to some embodiments of the present disclosure. Process 600 may be executed by the O2O service system 100. For example, the process 600 may be implemented as a set of instructions (e.g., an application) stored in storage device 160. In some embodiments, the processing engine 112 may execute the set of instructions and may accordingly be directed to perform the process 600 in an O2O service platform. The platform may be an Internet-based platform that connects service providers and requesters through the Internet. In some embodiments, the process 600 may be an embodiment of step 520 with reference to FIG. 5.

In 610, the processing engine 112 (e.g., the acquisition module 403) may obtain and/or determine a historical value of a second indicator of each of the plurality of sub-areas. In some embodiments, the second indicator may include a size, a population density, a building density, a number of service orders, a number of service providers, a number of service requesters, a difference between the number of service providers and the number of service requesters, a density of residential buildings, longitudinal and latitudinal coordinates, a total length of paved road, a total length of highway, or the like, or any combination thereof. The second indicator may be the same as or different from the first indicator.

The historical value of the second indicator may correspond to a designated historical time point and/or period. The designated historical time point may be any time point before the present moment. For example, the designated historical time point may be 10:00 am in Aug. 21, 2017. As another example, the designated historical time point may be 10:00 am every day in the past week. The designated historical period may be any continuous period or discontinuous period before the present moment. For example, the designated historical period may be past week, past month, or past year of the present moment. As another example, the designated historical time period may be peak hour or rush hours (e.g., 7:00 am to 9:00 am and/or 17:00 to 19:00 pm) every day in the past week.

In some embodiments, the designated historical period is determined so that it corresponds to the designated time period for which the value of the first indicator is determined. The level of correspondence can differ. For example, if the designated time period is 7:00 am to 9:00 am tomorrow (e.g., a Tuesday) morning, in certain embodiments the designated historical period may be 7:00 am to 9:00 am of the same week day (e.g. Tuesday) in the past 5 weeks; in certain embodiments the designated historical period may be 7:00 am to 9:00 am of all the past 5 week days; in certain embodiments the designated historical period may be 7:00 am to 9:00 of the past weeks having similar weather in the past 3 months.

The historical value of the second indicator corresponding to the designated historical time point or period may be an accumulated value, an average value, a median value, or any statistic of the second indicator in the designated historical time point or period. For example, the historical value of the second indicator may be a total number of service orders in the past week. As another example, the historical value of the second indicator may be an average daily number of service orders in the past week.

In some embodiments, the acquisition module 403 may obtain and/or determine the historical value of the second indicator for each sub-area based on historical data of the sub-area retrieved from a storage device in the O2O service system 100, such as the storage device 160.

In some embodiments, the processing engine 112 may simply designate each sub-area as a preliminary target sub-area. In some embodiments, a further determination is conducted. In 620, the processing engine 112 (e.g., the target sub-area determination module 402) may determine one or more preliminary target sub-areas among the plurality of sub-areas based on the historical values of the second indicator.

In some embodiments, the target sub-area determination module 402 may determine whether the historical value of the second indicator of a sub-area exceeds a first threshold. Upon a determination that the historical value of the second indicator of the sub-area exceeds the first threshold, the target sub-area determination module 402 may designate the sub-area as a preliminary target sub-area. In some embodiments, the first threshold may be a default parameter stored in a storage device (e.g., the storage device 160) or be set by a user (e.g., a user of the O2O service system 100) via a terminal.

Alternatively, the first threshold may be determined based on the historical values of the second indicator of the plurality of sub-areas. For example, the first threshold may be an average value (or a median value) of the historical values of the second indicator of all the sub-areas. As another example, the first threshold may be a first percentage of a sum of the historical values of the second indicator of all the sub-areas. The first percentage may be, such as 1%, 2%, 10%, or any positive value. For example, when the sum of the historical values of the second indicator (e.g., the number of service orders) of all sub-areas is 1000 and the first percentage is 2%, the first threshold may be 1000×2%=20. The target sub-area determination module 402 may determine a sub-area whose historical value of the second indicator is greater than 20 as the preliminary target sub-area.

In some embodiments, the target sub-area determination module 402 may rank the sub-areas based on the historical values of the second indicator. The target sub-area determination module 402 may also determine the preliminary target sub-areas among the sub-areas based on the ranking result. For example, the sub-areas may be ranked based on the historical values of the second indicator in descending order. The target sub-area determination module 402 may determine the top N sub-areas of which the sum of the historical values of the second indicator is greater than a fourth value as the preliminary target sub-areas. The fourth value may be a default parameter stored in a storage device (e.g., the storage device 160) or be set by a user (e.g., a user of the O2O service system 100) via a terminal.

Alternatively, the fourth value may be a second percentage of the sum of the historical values of the second indicator of the sub-area. The second percentage may be, such as but not limited to 50%, 60%, 70%, 80%, 90% or any positive value. For example, when the sum of the historical values of the second indicator (e.g., the number service orders) of all sub-areas is 1000 and the second percentage is 90%, the fourth value may be 1000×90%=900. The target sub-area determination module 402 may determine the top N sub-areas of which the sum of the historical values of the second indicator is greater than 900 as the preliminary target sub-areas.

In some embodiments, each of the preliminary target sub-areas is a sub-area, meaning that a sub-area is “designated” (determined) as a preliminary target sub-area without any change. In some embodiments, each of the preliminary target sub-areas may include one or more sub-areas. In certain embodiments, the target sub-area determination module 402 may integrate one or more sub-areas into a preliminary target sub-area based on the values of the second indicators of the sub-areas.

It should be noted that the above descriptions of process 600 are provided for the purposes of illustration, and not intended to limit the scope of the present disclosure. For persons having ordinary skills in the art, various modifications and changes in the forms and details of the application of the above method and system may occur without departing from the principles in the present disclosure. However, those variations and modifications also fall within the scope of the present disclosure. For example, steps 610 and 620 may be merged into one step.

FIG. 7 is a flowchart illustrating an exemplary process for determining a model related to an indicator according to some embodiments of the present disclosure. Process 700 may be executed by the O2O service system 100. For example, the process 700 may be implemented as a set of instructions (e.g., an application) stored in storage device 160. In some embodiments, the processing engine 112 may execute the set of instructions and may accordingly be directed to perform the process 700 in an O2O service platform. The platform may be an Internet-based platform that connects O2O service providers and requesters through the Internet. In some embodiments, the process 700 may be an embodiment of step 530 with reference to FIG. 5.

In 710, the processing engine 112 (e.g., the training module 405) may obtain historical feature information of one or more features and historical values of the first indicator of a plurality of preliminary target sub-areas.

The historical feature information and the historical values of the first indicator may correspond to a designated historical time (e.g., a designated historical time point or period). The designated historical time point or period may correspond to that described in connection with step 610, and the detailed descriptions are not repeated herein. In some embodiments, the training module 405 may obtain the historical feature information and the historical values of the first indicator of a preliminary target sub-area in every unit period during the designated historical period. For example, the training module 405 may obtain historical numbers of service orders and historical feature information of a preliminary target sub-area in every 5 minutes in the past month.

The features may include but not be limited to time, location, weather, traffic, policy, news, road condition, service order, service requester, or service provider, or the like, or any combination thereof. In some embodiments, the feature of the time may be associated with the designated historical time. In some embodiments, the feature of the location, weather, traffic, policy, news, road condition, service order, service requester, or service provider may be associated with the preliminary target sub-area. The historical feature information may include but not be limited to historical time information, historical location information, historical weather information, historical traffic information, historical policy information, historical news information, historical road condition information, historical service order information, historical service requester information, historical service provider information, or the like, or any combination thereof. The historical feature information may be substantially similar to the feature information as described in connection with step 540, and the descriptions thereof are not repeated here.

In some embodiments, the training module 405 may obtain the historical feature information of the one or more features from a storage device (e.g., the storage device 160) in the O2O service system 100 or another system (e.g., a weather condition platform, a traffic guidance platform, a government channel, or a news platform). In some embodiments, the historical feature information of the one or more features may be structured data encoded by the processing engine 112 into one or more electrical signals.

In 720, the processing engine 112 (e.g., the training module 405) may obtain a first portion of the historical feature information and the historical values of the first indicator from the historical feature information and the historical values of the first indicator. In some embodiments, the first portion of the historical feature information and the historical values of the first indicator may be applied in model training. In certain embodiments, the first portion may also be referred to as a training set.

In 730, the processing engine 112 (e.g., the training module 405) may obtain a preliminary model. In some embodiments, the preliminary model may utilize default settings (e.g., one or more preliminary parameters) determined by the O2O service system 100 or may be adjustable in different situations. In some embodiments, the preliminary model may include but not be limited to a decision tree model, a random forest model, a logistic regression model, a support vector machine (SVM) model, a Naive Bayesian model, a K-nearest-neighbor model, a K-means model, an AdaBoost model, a Neural Networks model, a Markov Chains model, or the like, or any combination thereof.

In some embodiments, the preliminary model may be a decision tree model, such as but not limited to a simple decision tree, a linear decision tree, an algebraic decision tree, a deterministic decision tree, a randomized decision tree, a nondeterministic decision tree, a quantum decision tree, or a gradient boosting decision tree. In some embodiments, the preliminary model may be the gradient boosting decision tree (GBDT) model.

In 740, the processing engine 112 (e.g., the training module 405) may determine predicted values of the first indicator corresponding to the first portion of the historical values of the first indicator based on the preliminary model and the first portion of the historical feature information. For example, the training module 405 may input the first portion of the historical feature information to the preliminary model and determine the predicted values of the first indicator based on the plurality of preliminary parameters.

In 750, the processing engine 112 (e.g., the training module 405) may determining a loss function based on the predicted values and the first portion of the historical values of the first indicator. The loss function may indicate an accuracy of the preliminary model. In some embodiments, the training module 405 may determine the loss function based on differences between the historical values of the first indicator in the first portion and the corresponding predicted values. In some embodiments, a difference between a historical value of the first indicator and the corresponding predicted value may be determined based on an algorithm including, for example, a mean absolute percent error (MAPE), a mean squared error (MSE), a root mean square error (RMSE), or the like, or any combination thereof.

In 760, the processing engine 112 (e.g., the training module 405) may determine whether the loss function (e.g., the differences between the historical values of the first indicator in the first portion and the corresponding predicted values) is less than a second threshold. The second threshold may be default settings in the O2O service system 100 or may be adjustable in different situations.

In response to a determination that the value of the loss function is less than the second threshold, the processing engine 112 may designate the preliminary model as a trained preliminary model related to the first indicator, and execute the process 700 to 770.

On the other hand, in some embodiments, in response to a determination that the value of the loss function is larger than or equal to the second threshold, the processing engine 112 may execute the process 700 to return to 730 to update the preliminary model until the loss function is less than the second threshold. For example, the processing engine 112 may update the plurality of preliminary parameters. Further, in some embodiments, if the processing engine 112 determines that under the updated parameters, the value of the loss function is less than the second threshold, the processing engine 112 may designate the updated preliminary model as a trained preliminary model related to the first indicator, and execute the process to 770. On the other hand, if the processing engine 112 determines that under the updated parameters, the value of the loss function is larger than or equal to the second threshold, the processing engine 112 may still execute the process 700 to return to 730 to further update the parameters. The iteration from steps 730 through 760 may continue until the processing engine 112 determines that under newly updated parameters the value of the loss function is less than the second threshold, and the processing engine 112 may execute the process 700 to 770.

In 770, the processing engine 112 (e.g., the training module 405) may determine a model validation parameter of the trained preliminary model based on the first portion and a second portion of the historical feature information and the historical values of the plurality of preliminary target sub-areas. The training module 405 may obtain the second portion of the historical feature information and the historical values of the first indicator from the historical feature information and the historical values of the first indicator. The second portion of the historical feature information and the historical values of the first indicator may be applied in model validation. In some embodiments, the second portion may also be referred to as a validation set. The first portion and the second portion may intersect each other or not. In some embodiments, the target sub-area determination module 402 may divide the historical feature information and the historical values into the first portion and the second portion exclusive from each other. The validation parameter may be used to evaluate the accuracy of the trained preliminary model.

In some embodiments, the validation parameter may include but not be limited to a precision, a recall, an F-score, a confusion matrix, a Receiver Operating Characteristic (ROC), Area under Curve (AUC), a variance, or the like. The ROC curve is a graphical plot that illustrates the diagnostic ability of a binary classifier system. The AUC is an area under the ROC curve.

In some embodiments, the training module 405 may validate the trained preliminary model related to the first indicator based on the AUC. The training module 405 may determine a first AUC by inputting the first portion of the historical feature information into the trained preliminary model. The training module 405 may also determine a second AUC by inputting the second portion of the historical feature information into the trained preliminary model. The validation parameter may be the difference between the first AUC and the second AUC.

In 780, the processing engine 112 (e.g., the training module 405) may determine whether the model validation parameter is less than a third threshold. The third threshold may be default settings in the O2O service system 100 or may be adjustable in different situations.

In response to a determination that the model validation parameter is less than the third threshold, the processing engine 112 may save the trained preliminary model as the trained model related to the first indicator in 790. In some embodiments, the processing engine 112 may save the trained model related to the first indicator in a storage medium (e.g., a storage device 160) in forms as structured data. The structured data of the trained model related to the first indicator may be constructed or retrieved by the processing engine 112 based on a B-tree or a hash table. In some embodiments, the structured data may be stored or saved as a form of a data library in the storage device.

On the other hand, in some embodiments, in response to a determination that the model validation parameter is larger than or equal to the third threshold, the processing engine 112 may execute the process 700 to return to 720 to re-train the preliminary model until the validation parameter is less than the third threshold. For example, the processing engine 112 may re-obtain a first portion of the historical feature information and the historical values of the first indicator, and execute steps 740 to 760 based on the re-obtained first portion to re-train the preliminary model. Alternatively, step 720 may be omitted, and the processing engine 112 may execute steps 730 to 760 to update the preliminary model based on the original first portion of the historical feature information and the historical values of the first indicator.

The iteration from steps 730 through 760 may continue until the processing engine 112 determines that the loss function of the first portion (or the re-obtained first portion) is less than the second threshold, and the processing engine 112 may execute the process 700 to 770. In 770, the processing engine 112 may re-obtain a second portion of the historical feature information and the historical values of the first indicator to validate the newly trained preliminary model. Alternatively, step 770 may be omitted, and the processing engine 112 may validate the newly trained preliminary model with the original second portion of the historical feature information and the historical values of the first indicator.

The iteration from steps 720 through 780 may continue until the processing engine 112 determines that under newly trained preliminary model validation parameter is less than the third threshold, and the processing engine 112 may save the newly trained preliminary model as the trained model related to the first indicator.

It should be noted that the above descriptions of process 700 are provided for the purposes of illustration, and not intended to limit the scope of the present disclosure. For persons having ordinary skills in the art, various modifications and changes in the forms and details of the application of the above method and system may occur without departing from the principles in the present disclosure. However, those variations and modifications also fall within the scope of the present disclosure. In some embodiments, one or more steps may be added or omitted. For example, steps 770 and 780 may be omitted. As another example, the trained model related to the first indicator may be determined based on a plurality of first portions of the historical feature information and the historical values of the first indicator, and/or validated based on a plurality of second portions of the historical feature information and the historical values of the first indicator.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment,” “one embodiment,” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “block,” “module,” “engine,” “unit,” “component,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 1703, Perl, COBOL 1702, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a software as a service (SaaS).

Furthermore, the recited order of processing elements or sequences, or the use of numbers, letters, or other designations, therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software-only solution—e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

1. A system, comprising:
at least one non-transitory computer-readable storage medium including a set of instructions;
at least one processor in communication with the at least one non-transitory computer-readable storage medium, wherein when executing the instructions, the at least one processor is directed to:
determine one or more preliminary target sub-areas among a plurality of sub-areas that make up an area;
obtain a trained model that is configured to generate a value for a first indicator based on one or more features related to each of the preliminary target sub-areas;
obtain, for each of the one or more preliminary target sub-areas, feature information of the one or more features, at least part of the feature information being associated with a designated time; and
determine a value of the first indicator at the designated time for each of the one or more preliminary target sub-areas based on the trained model and the feature information.

2. The system of claim 1, wherein to determine the one or more preliminary target sub-areas among the plurality of sub-areas, the at least one processor is further directed to:
obtain a historical value of a second indicator of each of the plurality of sub-areas; and
determine the one or more preliminary target sub-areas among the plurality of sub-areas based on the historical values of the second indicator of the plurality of sub-areas.

3. The system of claim 2, wherein to determine the one or more preliminary target sub-areas among the plurality of sub-areas based on the historical values of the second indicator of the plurality of sub-areas, the at least one processor is further directed to:
determine, for each of the plurality of sub-areas, whether the historical value of the second indicator exceeds a first threshold; and
for each of the plurality of sub-areas, upon a determination that the historical value of the second indicator exceeds the first threshold, designate the sub-area as the one or more preliminary target sub-areas.

4. The system of claim 1, wherein the at least one processor is further directed to:
divide the area into the plurality of sub-areas according to a pre-determined rule before determining one or more preliminary target sub-areas.

5. The system of claim 1, wherein the at least one processor is further directed to:
determine one or more target sub-areas based on the values of the first indicator of the one or more preliminary target sub-areas.

6. The system of claim 5, wherein the at least one processor is further directed to:
redistribute one or more resources among the target sub-areas based on the values of the first indicator of the preliminary target sub-areas.

7. The system of claim 1, wherein to obtain the trained model related to the first indicator, the at least one processor is further directed to:
(1) obtain historical feature information of the one or more features and historical values of the first indicator of a plurality of preliminary target sub-areas;
(2) train a preliminary model with a first portion of the historical feature information and historical values by using a loss function, wherein the loss function is based on predicted values generated by the preliminary model and the first portion of the historical values of the first indicator; and
(3) repeat steps (1)-(2) upon a determination that the loss of function is more than a second threshold, or designate the preliminary model as a trained preliminary model related to the first indicator upon a determination that the loss function is less than the second threshold.

8. The system of claim 7, wherein the at least one processor is further configured to:
(4) verify the trained preliminary model with a second portion of the historical feature information and historical values by determining a model validation parameter is less than a third threshold; and
(5) repeat steps (1)-(3) upon a determination that the validation parameter is more than the third threshold, or designate the trained preliminary model as the trained model upon a determination that the model validation parameter is less than the third threshold.

9. The system of claim 1, wherein the trained model related to the first indicator is a gradient boosting decision tree (GBDT) model.

10. The system of claim 1, wherein the first indicator is associated with at least one of a service supply, a service demand, and a demand-supply gap of an Online to Offline (O2O) service.

11. The system of claim 1, wherein the one or more features comprise at least one of time, location, weather, traffic, policy, news, road condition, service order, service requester, or service provider.

12. A method, comprising:
determining one or more preliminary target sub-areas among a plurality of sub-areas that make up an area;
obtaining a trained model that is configured to generate a value for a first indicator based on one or more features related to each of the preliminary target sub-areas;
obtaining, for each of the one or more preliminary target sub-areas, feature information of the one or more features, at least part of the feature information being associated with a designated time; and
determining a value of the first indicator at the designated time for each of the one or more preliminary target sub-areas based on the trained model and the feature information.

13. The method of claim 12, wherein the determining the one or more preliminary target sub-areas among the plurality of sub-areas further comprises:
obtaining a historical value of a second indicator of each of the plurality of sub-areas; and
determining the one or more preliminary target sub-areas among the plurality of sub-areas based on the historical values of the second indicator of the plurality of sub-areas.

14. The method of claim 13, wherein the determining the one or more preliminary target sub-areas among the plurality of sub-areas based on the historical values of the second indicator of the plurality of sub-areas further comprises:
determining, for each of the plurality of sub-areas, whether the historical value of the second indicator exceeds a first threshold; and
for each of the plurality of sub-areas, upon a determination that the historical value of the second indicator exceeds the first threshold, designating the sub-area as the one or more preliminary target sub-areas.

15. The method of claim 12, further comprising:
dividing the area into the plurality of sub-areas according to a pre-determined rule before determining one or more preliminary target sub-areas.

16. The method of claim 12, further comprising:
determining one or more target sub-areas based on the values of the first indicator of the one or more preliminary target sub-areas.

17. The method of claim 16, further comprising:
redistributing one or more resources among the target sub-areas based on the values of the first indicator of the preliminary target sub-areas.

18. The method of claim 12, wherein the obtaining the trained model related to the first indicator further comprises:
(1) obtaining historical feature information of the one or more features and historical values of the first indicator of a plurality of preliminary target sub-areas;
(2) training a preliminary model with a first portion of the historical feature information and historical values by using a loss function, wherein the loss function is based on predicted values generated by the preliminary model and the first portion of the historical values of the first indicator; and
(3) repeating steps (1)-(2) upon a determination that the loss of function is more than a second threshold, or designating the preliminary model as a trained preliminary model related to the first indicator upon a determination that the loss function is less than the second threshold.

19. The method of claim 18, further comprising:
(4) verifying the trained preliminary model with a second portion of the historical feature information and historical values by determining a model validation parameter is less than a third threshold; and
(5) repeating steps (1)-(3) upon a determination that the validation parameter is more than the third threshold, or designating the trained preliminary model as the trained model upon a determination that the model validation parameter is less than the third threshold.

20-22. (canceled)

23. A non-transitory computer readable medium embodying a computer program product, the computer program product comprising instructions configured to cause a computing device to:
determine one or more preliminary target sub-areas among a plurality of sub-areas that make up an area;
obtain a trained model that is configured to generate a value for a first indicator based on one or more features related to each of the preliminary target sub-areas;
obtain, for each of the one or more preliminary target sub-areas, feature information of the one or more features, at least part of the feature information being associated with a designated time; and
determine a value of the first indicator at the designated time for each of the one or more preliminary target sub-areas based on the trained model and the feature information.
